(19) United States
(12) Patent Application Publication
(10) Pub. No.: US 2018/0305492 A1
(43) Pub. Date: Oct. 25, 2018

(54) Nanocapsules as Thermolatent Polymerization Catalysts or Initiators

(71) Applicants: Henkel AG & Co. KGaA, Duesseldorf (DE); Max-Planck-Gesellschaft Zur Foerderung Der ..., Muenchen (DE)

(72) Inventors: Andreas Taden, Duesseldorf (DE); Ann-Christin Bijlard, Duesseldorf (DE); Anne Hansen, Nettersheim (DE); Katharina Landfester, Mainz (DE)

(21) Appl. No.: 15/949,180

(22) Filed: Apr. 10, 2018

Related U.S. Application Data
(63) Continuation of application No. PCT/EP2016/073397, filed on Sep. 30, 2016.

(30) Foreign Application Priority Data
Oct. 12, 2015 (EP) 15189377.3

(51) Int. Cl. C08G 18/24; C08F 20/12; C08K 5/103; C08L 75/14

(52) U.S. Cl. CPC C08G 18/244; C08F 20/12; B82Y 30/00; C08L 75/14; C08L 2205/18; C08K 5/103

(57) ABSTRACT

The invention relates to a method for producing special nanocapsules, which can be used as thermolatent polymerization catalysts, in particular for the polarization of polyurethanes, by means of a high shear process, wherein the method comprises: (i) emulsification of a reaction mixture into a continuous aqueous phase comprising at least one stabilizer, wherein the reaction mixture comprises, based on the total weight of the reaction mixture: (a) 10.0 to 99.0 wt. % of a monomer mixture which comprises, based on the total weight of the monomer mixture: (a1) 2.5 to 19.0 wt. % of at least one simply ethylenically unsaturated C₃₋₅-carboxylic acid monomer; (a2) 76.0 to 97.5 wt. % of at least one simply ethylenically unsaturated C₃₋₅-carboxylic acid-C₁₋₁₀-alkyl ester monomer; (a3) 0.0 to 5.0 wt. % of at least one monomer which bears at least two ethylenically unsaturated groups; (b) 1.0 to 70.0 wt. % of at least one polymerization catalyst or initiator; (c) 0.0 to 89.0 wt. % of at least one hydrophobic release agent, wherein the release agent preferably has a Hansen parameter ∂t of less than 20; and (d) 0.0 to 10.0 wt. % of at least one ultrahydrophobic compound which is different from the release agent; (ii) optionally homogenizing the emulsion from step (i); and (iii) polymerizing the monomers. The invention further relates to the nanocapsules produced by means of the described methods, to the use thereof, and to agents which contain these nanocapsules.

The present invention relates to a method for producing special nanocapsules, which can be used as thermolatent polymerization catalysts/initiators, in particular for polymerizing polyurethanes (PU), by means of a high-shear process, the method comprising producing an emulsion of a mixture of ethylenically unsaturated monomers and of a catalyst/initiator in an aqueous solution, optionally homogenizing in order to produce a miniemulsion, and polymerizing. The invention further relates to the nanocapsules produced by means of the described methods, to the use thereof, and to agents which contain said nanocapsules.

Polyurethanes are common materials that are used in a wide range of fields. However, catalysts are often required in particular for systems based on aliphatic isocyanates in order to accelerate the polymerization reaction of polyurethanes and to lower the curing temperatures. Mainly organotin compounds are used for this purpose, with dibutyltin dilaurate (DBTL) being the most widespread catalyst. However, owing to growing concerns over the toxicity of DBTL, other tin-based catalysts, such as tin neodecanoate, are now also used.

Generally, the catalysts used are highly reactive, which radically shortens the pot lives of the polyurethane materials. A range of approaches are known for overcoming this drawback, such as the use of blocked isocyanates or UV-curable systems. However, the downside to these approaches is in turn that high temperatures are required for activation and that the fields of application are limited to those in which UV activation is feasible. A further alternative is thermolatent catalysts, i.e., heat-activated, delayed-effect catalysts. For this purpose, tin(II) and tin(IV) alkoxy catalysts, for example, have been proposed (Zöller et al. (2013) Inorganic Chem. 52(4): 1872-82). However, these require complex synthesis methods. A further alternative is systems based on a physical barrier, with microcapsules already being well established in the prior art in this respect. Microcapsules have a size of from 1 to 1,000 μm and are typically mechanically opened by being broken open, the contents thus being released. However, microcapsules are disadvantageous in that, when used, they tend to coagulate or sediment and the use thereof is limited to applications in which the size of the capsules does not have a negative impact, such as in infusion processes in the composite field, in which the fibers used as reinforcement can prevent the penetration of a laid scrim by a microcapsule-containing polymer resin by trapping the microcapsules.

Nanocapsules are an alternative to the known microcapsules. However, owing to their size in the range of from only 50 to 500 nm (z-average from dynamic light scattering (DLS)), said capsules cannot be mechanically opened by being broken open, but rather they must be formulated such that they open in response to particular signals or ambient conditions. However, in the case of nanocapsules, it is difficult to achieve high encapsulation efficiency, which can be attributed to the small size and to the fact that the thin shell of the nanocapsules is very limited in its capacity to act as a diffusion barrier without special provisions or modifications.

The object of the present invention was therefore to provide nanocapsules that overcome the existing drawbacks and are suitable as thermolatent catalysts.

The present invention achieves this object by the nanocapsules being produced in one step by means of a combined emulsion/miniemulsion polymerization formulation consisting of a monomer mixture and a catalyst/initiator substance to be encapsulated and optionally a hydrophobic release agent. The nanocapsules that can be thus obtained have a core/shell morphology, the polymer made of the monomers forming the shell, and the catalyst/initiator substance and optionally the release agent forming the core.

The nanocapsules that can be thus obtained are thermolatent, i.e., the contents of the nanocapsules can be released in a controlled manner by increasing the temperature. However, the contents may be released by means of alternative mechanisms. In the first case, when the temperature is increased, the catalyst/initiator substance itself is sufficiently compatible with the capsule shell that said substance overcomes the barrier of the nanocapsule shell (although, at the temperatures used during encapsulation and in storage, said substance is sufficiently incompatible that encapsulation is made possible and premature release is prevented). In the second case, a release agent is used such that, when the temperature is increased, the capsule shell swells, thus rendering it permeable to the contents of the capsule, i.e., the catalyst/initiator substance. For this purpose, when the temperature is increased, the release agent is sufficiently compatible with the capsule shell that said agent has a softening effect, but is sufficiently incompatible at the temperatures used during production and in storage that efficient encapsulation is made possible. In a third case, a propellant is used as the release agent, the propellant being selected such that, at a specified temperature, said propellant evaporates and breaks the nanocapsules open as a result of the increasing pressure therein, thus releasing the catalyst. The nanocapsules are further distinguished by very high encapsulation efficiency and high colloidal stability and, under standard conditions, very effectively prevent the catalyst/initiator from being released, and therefore PU materials formulated using said nanocapsules have very long pot lives.

In a first aspect, the invention therefore relates to a method for producing nanocapsules containing at least one polymerization catalyst/initiator, characterized in that the method comprises:
(i) emulsifying a reaction mixture in a continuous aqueous phase, in particular water, that comprises at least one stabilizer, in particular at least one surfactant, the reaction mixture comprising, based on the total weight of the reaction mixture:
   (a) 10.0 to 99.0 wt. % of a monomer mixture which, based on the total weight of the monomer mixture, comprises:
   (a1) 2.5 to 19.0 wt. %, in particular 5.0 to 12.0 wt. %, of at least one ethylenically monounsaturated C₃₋₅ carboxylic acid monomer;
   (a2) 76.0 to 97.5 wt. %, in particular 85.0 to 95.0 wt. %, of at least one ethylenically monounsaturated C₃₋₅ carboxylic acid C₁₋₁₀ alkyl ester monomer;
   (a3) 0.0 to 5.0 wt. %, in particular 0.0 to 3.0 wt. %, of at least one monomer having at least two ethylenically unsaturated groups, preferably at least one divinyl benzene or one diester or triester of a C₂₋₁₀ polyol with ethylenically unsaturated C₃₋₅ carboxylic acids, in particular at least one diester or triester of a C₂₋₁₀ alkane diol or triol with ethylenically unsaturated C₃₋₅ carboxylic acids,
   (b) 1.0 to 70.0 wt. %, preferably 1.0 to 30.0 wt. %, of at least one polymerization catalyst or initiator, preferably at least one catalyst that catalyzes the polyaddition reaction of compounds having isocyanate groups and NCO-reactive groups to form polyurethanes, in particular at least one organotin compound; and
   (c) 0.0 to 89.0 wt. % of at least one hydrophobic release agent, the release agent having a Hansen parameter δt of less than 20; and
   (d) 0.0 to 10.0 wt. % of at least one ultrahydrophobic compound that is different from the release agent, preferably at least one optionally fluorinated C₁₂₋₂₈ hydrocarbon, more preferably at least one C₁₄₋₂₆ alkane;
(ii) optionally homogenizing the emulsion from step (i); and
(iii) polymerizing the monomers.
   A further aspect is directed to the nanocapsules that can be obtained by means of the above-mentioned methods, and to the use therefore for catalyzing polymerization reactions, in particular of polyurethanes.

Yet a further aspect relates to agents and compositions that contain the nanocapsules of the invention.

“At least one,” as used herein, means one or more, i.e., one two, three, four, five, six, seven, eight, nine, or more. In relation to an ingredient, the expression refers to the type of ingredient and not to the absolute number of molecules. “At least one release agent” therefore means, for example, at least one type of release agent, i.e., that one type of release agent or a mixture of a plurality of different release agents can be used. Together with weight information, this information refers to all compounds of the indicated type that are contained in the composition/mixture, i.e., indicates that the composition does not contain any other compounds of this type beyond the indicated quantity of the corresponding compounds.

Unless explicitly indicated otherwise, all percentages that are cited in connection with the compositions described herein refer to wt. %, in each case based on the mixture in question.

“Emulsion” or “miniemulsion,” as used interchangeably herein, refers to an oil-in-water (O/W) emulsion in which the emulsified phase is in the form of droplets or particles, preferably having an approximately spherical shape, in the continuous water phase. The droplets/particles have an average size, and an average diameter when they have an approximately spherical shape, in the size range of from 50 to 500 nm, preferably 100 to 300 nm. The term “nanocapsule,” as used herein, refers to the emulsified, polymerized particles that are produced by means of the methods described herein. Said particles have the above-mentioned average size in the range of from 50 to 500 nm, preferably from 100 to 300 nm. The above-mentioned average values refer to the z-average from dynamic light scattering in accordance with ISO 22412:2008.

The combined emulsion/miniemulsion polymerization technique described herein simplifies the synthesis of the nanocapsules by the nucleation occurring substantially in the droplets, thus making it possible to introduce highly hydrophobic compounds. On account of the comparatively larger amounts of water-soluble (meth)acrylic acid, systems of this kind cannot be considered to be conventional miniemulsion systems, but are rather a combination of emulsion and miniemulsion polymerization that combines the advantages of the two techniques.

In various embodiments of the invention, the monomers for the capsule shell are selected such that the copolymer that can be obtained from the monomer mixture has a theoretical glass transition temperature T_{g}, calculated in a manner equivalent to the Fox equation, of 95° C. or more, in particular 100° C. or more, preferably 105° C. or more. In particular if a volatile propellant, i.e., having a boiling point of up to 200° C., is used, these T_{g} values are preferred in order to ensure a sufficient barrier effect for the capsule shell.

“Glass transition temperature” or “T_{g},” as used herein, refers to the temperature at which a given polymer transitions from a solidified, glass-like state into a rubber-like state and the polymer segmental motion is restored. Said temperature is linked to the stiffness and the free volume of a polymer and can be experimentally measured by means of known methods, such as dynamic mechanical thermal analysis (DMTA) or differential scanning calorimetry (DSC). Both methods are known in the art. It is noted that, depending on the measurement method and the measurement conditions used or the thermal history of the polymer sample, different glass transition temperatures may be obtained for an identical polymer system. In fact, specifying a defined temperature is in itself subject to a certain degree of inaccuracy since glass transition typically takes place within a temperature range. Furthermore, nanocapsule glass temperatures are experimentally very difficult to establish and there is no single suitable determination method. Unless explicitly indicated otherwise, the glass transition temperatures indicated herein are therefore theoretically calculated in a manner equivalent to the Fox equation. In the following, some of the correspondingly calculated values for the glass transition temperature are also referred to as “estimated.” When the glass transition temperature is reached or exceeded, the capsule shell is increasingly expanded as a result of the increase in polymer motion, and may thus gradually lose its barrier effect at least to a certain degree, i.e., become more permeable to the encapsulated contents. The thermolatency can therefore be induced at least in part above the T_{g} of the shell polymer and by increasing the temperature above the T_{g}.

The Fox equation (cf. T. G. Fox, Bull. Am. Phys. Soc. 1 (1956) p. 123) stipulates that the reciprocal glass transition temperature of a copolymer can be calculated from the weight proportions of the comonomers used and the glass transition temperatures of the corresponding homopolymers of the comonomers:

$$\frac{1}{{T}_{g}} = {\sum }_{i = 1}^{n} \frac{{w}_{i}}{{T}_{g , i}}$$

In the general equation, n represents the number of monomers used, i represents the index relating to the monomers used, wᵢ represents the mass proportion of the particular monomer i (in wt. %), and T_{g,i} represents the particular glass transition temperature of the homopolymer consisting of the particular monomers i in K (Kelvin).

The values for the glass transition temperature of the corresponding homopolymers can also be obtained from relevant reference works (cf. J. Brandrup, E. H. Immergut, E. A. Grulke, “Polymer Handbook”, 4th edition, Wiley, 2003); for some selected monomers, the corresponding homopolymer glass transition temperatures that are relevant or used for calculation are listed below: methyl acrylate (MA), T_{g}=10° C.; methyl methacrylate (MMA), T_{g}=105° C.; ethyl acrylate (EA), T_{g}=−24° C.; ethyl methacrylate (EMA), T_{g}=65° C.; n-butyl acrylate (BA), T_{g}=−54° C.; n-butyl methacrylate (BMA), T_{g}=20° C.; n-hexyl acrylate (HA), T_{g}=57° C.; n-hexyl methacrylate (HMA), T_{g}=−5° C.; styrene (S), T_{g}=100° C.; cyclohexyl acrylate (CHA), T_{g}=19° C.; cyclohexyl methacrylate (CHMA), T_{g}=92° C.; 2-ethylhexyl acrylate (EHA), T_{g}=−50° C.; 2-ethylhexyl methacrylate (EHMA), T_{g}=−10° C.; isobornyl acrylate (IBOA), T_{g}=94° C.; isobornyl methacrylate (IBOMA), T_{g}=110° C.; acrylic acid (AA), T_{g}=105° C.; methacrylic acid (MAA), T_{g}=228° C.

It is noted that, in the present case, when vinylically or ethylenically polyunsaturated, radical-polymerizable monomers (known as “branching agents” or “crosslinking agents”) are used, these are not included in the calculation of the glass transition temperature. The values calculated by means of the indicated equation as described above are referred to herein as “theoretically calculated in a manner equivalent to the Fox equation” or “estimated.”

The method described herein is based on polymerization-induced phase separation, which is dictated by the interaction with water and in which a hydrophobic compound is enclosed in a slightly less hydrophobic polymer shell. The formation of nanocapsules by means of phase separation is based on the low solubility of a polymer in a solution. For example, an organic liquid intended to be enclosed can be used as a solvent for the monomers; however, it is no longer possible for the same liquid to act as a solvent for the polymer after the polymerization.

In various embodiments of the invention, the Hansen parameter δ_{d} of the polymer of the capsule shell is 15-19, preferably 16-18, more preferably approximately 17, the Hansen parameter δₚ is 10-14, preferably 11-13, more preferably approximately 12, and the Hansen parameter δₕ is 13-17, preferably 14-16, more preferably approximately 15, in particular 15.3. The Hansen parameter it is preferably 23-28, more preferably 24-27, even more preferably 25-26. Unless explicitly indicated otherwise, the Hansen parameter is always specified herein in the unit MPa^{1/2}.

The Hansen parameter is a parameter for comparing the solubility or miscibility of different substances that is common in polymer chemistry. This parameter was developed by Charles M. Hansen in order to predict the solubility of one material in another. Here the cohesive energy of the liquid is taken into consideration, which energy can be divided into at least three different forces or interactions: (a) dispersion forces between the molecules δ_{d}, (b) dipolar intermolecular forces between the molecules δₚ, and (c) hydrogen bridge bonds between the molecules δₕ. These three parameters can be combined to form one parameter δₜ according to formula δₜ²=δ_{d}²+δₚ²+δₕ². The more similar the Hansen parameters of different materials, the more intermiscible said materials are. Unless indicated otherwise, the values indicated herein for the Hansen parameter refer to values as indicated or calculated by Hansen in Hansen Solubility Parameters. A User's Handbook, Vol. 2, Taylor & Francis Group, Boca Raton, 2007, in particular at room temperature (20° C.). The Hansen parameters for the capsule shell are determined in particular as described in Angew. Chem. Int. Ed. 2015, 54, 327-330.

For a mixture of solvents, the Hansen solubility parameters can be calculated by means of the volume fraction of the two solvents. The following equation can be used to calculate the parameter δₓ for two solvents S1 and S2, where x=h, d or p:

δₓ=(ϕ₁δₓ₁)+(ϕ₂δₓ₂)

In a 3D plot, the three solubility parameters for a solvent represent the coordinates of an individual point in three-dimensional space. For polymers P, the three parameters represent the coordinates of the center of a “solubility sphere” having the radius R₀ (interaction radius). This sphere represents the region in which the polymer is soluble (for linear polymers) or in which it can swell (in the case of a crosslinked polymer network).

The Hansen solubility parameters can thus be determined by means of swelling experiments in solvents of which the Hansen parameters are known. If the polymer is soluble or is swollen in the solvent, the Hansen parameter of the solvent is within the solubility sphere of the polymer. For two substances, for example solvent S and polymer P, the “distance” Rₐ between the solubility parameters of said components can be calculated by means of the following equation (see C. M. Hansen, Hansen Solubility. Parameters A User's Handbook, Vol. 2, Taylor & Francis Group, Boca Raton, 2007):

(Rₐ)²=4(δ_{dS}−δ_{dP})²+(δ_{pS}−δ_{pP})²+(δ_{hS}−δ_{hP})²

A high affinity or a high solubility requires Rₐ to be lower than R₀.

In order to achieve phase separation during polymerization and thus a core/shell structure, the solubility of the polymer in the core material in question should be low.

Determining the Hansen solubility parameters of the polymer used can therefore be used to avoid high solubility of the polymer in the core material.

From the radius of the solubility sphere R₀ and the values for Rₐ for the core materials, it is possible to calculate what is referred to as the relative energy difference (RED) of the system in question:

RED=Rₐ/R₀

An RED value of 0 is found if the energy difference or the difference between the Hansen solubility parameters of the compared materials is 0. A value of less than one indicates high affinity, and a value of more than one indicates low affinity between the materials. Or in other words, an RED value of less than or equal to one indicates solubility, and an RED value of more than one indicates incompatibility and thus immiscibility. Accordingly, a comparison of the core and shell substances should result in a high RED value in order to achieve phase separation during polymerization.

In various embodiments of the invention, the compound to be encapsulated or the mixture of compounds to be encapsulated, i.e., the catalyst/initiator and optionally the release agent and other components that may be used, satisfies the above relationship such that RED is >1. In particular, Rₐ/R₀ is >1, where R₀=8-15, in particular 10-13, preferably 11-12, more preferably approximately 11.3, most preferably 11.3. Unless explicitly indicated otherwise, R₀ and Rₐ is always specified herein in the unit MPa^{1/2}.

In the methods described herein, the compound/mixture to be encapsulated, i.e., the catalyst/initiator or the combination of release agent, in particular propellant, and catalyst and optionally ultrahydrophobic compound, is liquid under homogenization and/or polymerization conditions, preferably at room temperature (20° C.) and normal pressure (1,013 mbar). “Liquid,” as used in this connection, includes all substances that are flowable under said conditions.

In various embodiments, it may be advantageous, under the emulsification/homogenization conditions, for the monomers in the monomer mixture to be soluble, at least in part, in the compound/mixture to be encapsulated. In various embodiments, the monomer mixture may therefore be used as a solution of the monomers in at least one hydrophobic compound, typically in the catalyst/initiator and/or the release agent or propellant. In various embodiments, the catalyst/initiator compound to be encapsulated may be a solid that is soluble in the release agent/propellant and optionally in the ultrahydrophobic compound. Although not preferred according to the invention, the compound mixture to be encapsulated and the monomers may preferably also be dissolved in an organic solvent, and the resulting solution is emulsified in step (i) in the continuous phase.

So that the catalyst/initiator compound and/or the release agent can be effectively encapsulated, it is necessary for these to be sufficiently hydrophobic that they do not react with the polymer formed of the monomers and thus do not swell said polymer to too great a degree under synthesis and storage conditions and thereby render said polymer more permeable.

In various embodiments, it is therefore preferred for the catalyst/initiator compound to have a Hansen parameter δₜ of less than 20, preferably less than 19, in particular less than 15; and/or to have a Hansen parameter δₕ of less than 12, preferably less than 10, more preferably less than 6, in particular less than 2. In various embodiments, the at least one catalyst/initiator may have, for example, a Hansen parameter δₕ of 0. In various embodiments of the invention, the catalyst/initiator compound satisfies, in particular if said compound is used without a release agent, the above relationship between Hansen parameters of the shell polymer and Hansen parameters of the catalyst/initiator such that RED is >1. In particular, Rₐ/R₀ is >1, where R₀=8-15, in particular 10-13, preferably 11-12, more preferably approximately 11, most preferably 11.3.

It is further preferred for the hydrophobic compounds, i.e., the release agent, the catalyst/initiator and the ultrahydrophobic compound, not to produce a highly interfering side reaction during radical polymerization (e.g., as a result of radical scavengers, such as phenols) or with the monomers (e.g., no Michael reaction). Under the conditions used, the hydrophobic compounds are therefore preferably inert to the monomers and the reactants used during polymerization (with the exception of deliberately used reactive release agents, which are described in more detail below). A compound to be encapsulated can be considered to interfere with polymerization to too great a degree if, even once reinitiation or post-polymerization (see description further below) has taken place, a total monomer conversion of 80%, preferably 90% and particularly preferably 95%, is not exceeded. (Headspace) gas chromatography, which can also be used to determine the encapsulation efficiency, can ideally be used as a determination method. Furthermore, this method makes it possible not only to quantitatively determine the release kinetics, but also to effectively determine the conversion for most monomers. If, in certain cases, not all the comonomers used can be measured by chromatographic methods (more difficult to determine the total monomer conversion), it is sufficient to carry out a quantitative determination of individual comonomers which, cumulatively, make up at least 50% of the total monomer composition. In this case, a compound to be encapsulated is considered to interfere to too great a degree if the cumulative conversion of at least 50% of the monomers used is <80%, preferably <90%, and particularly preferably <95%.

In various embodiments, the catalyst or initiator used is a compound that can catalyze or initiate the polymerization reaction of particular monomers or prepolymers. Possible compounds are, for example, known olefin catalysts, including metallocene and ligands/complex compounds, which contain, for example, lanthanide, actinide, titanium, chromium, vanadium, cobalt, nickel, zirconium and/or iron, organometallic compounds, such as organic compounds based on tin, bismuth or titanium, metathesis catalysts (Schrock, Grubbs, molybdenum, ruthenium), or also organic compounds, such as an organic peroxides or tertiary amines, such as DABCO, DBU. Particularly preferably, catalysts for polyurethane synthesis are, for example, organotin compounds, such as DBTL (dibutyltin dilaurate), which is not preferred for reasons of toxicity, and in particular tin neodecanoate (tributyltin neodecanoate). Furthermore, the catalyst/initiator is not a catalyst/initiator for polymerizing the monomers that form the capsule shell, i.e., are different from a catalyst/initiator of this kind.

As already described above, it is preferred for the catalyst/initiator compound to be a hydrophobic compound, i.e., to have a Hansen parameter as indicated above. In embodiments of this kind in which, when the temperature is increased, the catalyst/initiator is sufficiently compatible with the capsule shell that it penetrates said shell, the use of a release agent can be omitted. In this case, the release mechanism is based, firstly, on the nanocapsules having a temperature sensitivity dependent on the T_{g} of the copolymer. An increase in the temperature results in greater motion of the polymer chains in the shell and thus in an expansion of the polymer shell, which thus becomes more permeable. Secondly, when the temperature is increased, the catalyst/initiator also has a softening effect on the capsule shell. However, it is preferred for the catalyst/initiator to be used together with a release agent that facilitates this mechanism or additionally acts as a propellant.

In various embodiments, the release agent is selected such that the catalyst/initiator is sufficiently soluble therein. The solubility is, for liquid compounds, preferably 20 g/I at room temperature (20° C.) or, for solid compounds, at a temperature that corresponds to the melting point of the compound Tm+20° C. The melting point can be determined according to the DIN EN ISO 1 1357-3:201 1 standard by means of DSC at a heating rate of 10 K/min. In order to determine the solubility, a Metrohm photometer 662 provided with a measurement probe can be used to determine the transparency. For the measurement, visible light (whole spectrum) is guided via optical fibers to the probe, which is submerged in the liquid sample. The light is emitted by the probe tip, travels through the sample solution, is reflected by a mirror, and is then guided to the detector via optical fibers. An optical filter can be used upstream of the detector in order to allow a particular wavelength to be selectively measured. For the present measurements, a wavelength of 600 nm was measured. An Ahlborn Almemo multimeter was used to digitally record the transmissivity (analog output of the photometer), and a transparency of ≥98% (at the selected wavelength) was taken to mean complete solubility.

Furthermore, the release agent is hydrophobic and preferably has a Hansen parameter δₜ of less than 20. In this case, it is particularly preferred for the release agent to have a Hansen parameter δₜ of less than 19, in particular less than 15; and/or to have a Hansen parameter δh of less than 12, preferably less than 10, more preferably less than 6, in particular less than 2. In various embodiments, the at least one release agent may have, for example, a Hansen parameter δₕ of 0. In various embodiments of the invention, the release agent satisfies the above relationship between Hansen parameters of the shell polymer and Hansen parameters of the release agent, or of the mixture of release agent and catalyst/initiator, such that RED is >1. In particular, Rₐ/R₀ is >1, where R₀=8-15, in particular 10-13, preferably 11-12, more preferably approximately 11.3, most preferably 11.3.

In various preferred embodiments, the release agent is liquid under homogenization and/or polymerization conditions, preferably at room temperature (20° C.) and normal pressure (1,013 mbar).

In various embodiments, the release agent may be a reactive release agent that, during polymerization, is copolymerized with the capsule shell at least in part. Examples of suitable compounds include, without being limited hereto, castor oil, cardanol and derivatives thereof, and other long-chain hydrophobic polyols and monoalcohols.

In various, particularly preferred embodiments, the release agent is a hydrophobic propellant, preferably a hydrocarbon, having a boiling point of from 50 to 200° C., preferably 60 to 150° C., more preferably 80 to 120° C. The indicated boiling point refers to the boiling point under standard conditions, i.e., at normal pressure (1,013 mbar). In various embodiments, the propellant is a C₆₋₁₀ hydrocarbon, preferably a C₆₋₁₀ alkane, in particular isooctane (2,2,4-trimethyl pentane), or a mixture of said compounds. The propellant is preferably liquid under standard conditions and may be used to dissolve the monomers and optionally also the catalyst compound therein. The indicated boiling points allow the nanocapsules to be broken open by being heated to temperatures above said boiling points since the propellant evaporates in the process and the rising pressure causes the nanocapsules to burst.

The invention is described in the following with reference to selected specific embodiments. However, it is not intended for the invention to be limited to these embodiments, but for it to be possible to easily adapt the invention by being able to use other monomers, stabilizers/surfactants and initiators. Moreover, this also applies to the release agents/propellants and catalysts/initiators that are explicitly mentioned and tested by way of example. Embodiments of this kind are also within the scope of the invention.

In a first step of the method according to the invention, a stabilized emulsion is produced. The emulsion contains the above-described monomer mixture and at least one stabilizer, in particular a surfactant, the catalyst/initiator, optionally the release agent and optionally one or more ultrahydrophobic compounds in the form of an emulsion in an aqueous solvent. The aqueous solvent contains water as the main component (more than 50, in particular more than 80 vol. %), or may consist entirely of water. In various embodiments, the aqueous solvent may contain one or more non-aqueous solvents, for example selected from monovalent or polyvalent alcohols, alkanol amines or glycol ethers, provided that these are water-miscible in the given concentration ranges.

These additional solvents are preferably selected from ethanol, n-propanol or isopropanol, butanol, glycol, propanediol or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or monoethyl ether, diisopropylene glycol monomethyl or monoethyl ether, methoxy-, ethoxy- or butoxytriglycol, 1 butoxyethoxy-2-propanol, 3-methyl-3-methoxybutanol, propylene glycol t-butyl ether and mixtures thereof. In the aqueous solvent, solvents of this kind may be used in amounts of between 0.5 and 35 wt. %, but preferably less than 30 wt. % and in particular less than 25 wt. %.

The monomers used in the described methods are in particular ethylenically unsaturated carboxylic acids and the alkyl esters thereof.

In various embodiments, the at least one ethylenically monounsaturated C₃-C₅ carboxylic acid monomer is selected from methacrylic acid (MAA), acrylic acid (AA), fumaric acid, methyl maleic acid, maleic acid, itaconic acid or mixtures of two or more thereof. Methacrylic acid (MAA), acrylic acid (AA) or mixtures thereof are particularly preferred. Methacrylic acid is most preferred. These are used, based on the monomer mixture, in particular in amounts of from 2.5 to 19 wt. %, preferably from 5 to 12 wt. %.

In various embodiments, the at least one ethylenically monounsaturated C₃₋₅ carboxylic acid C₁₋₁₀ alkyl ester monomer is an acrylic acid or methacrylic acid alkyl ester or a mixture thereof. Methacrylic acid C₁₋₅ alkyl ester monomers, in particular methacrylic acid methyl ester (MMA), methacrylic acid n-butyl ester (BMA) or a mixture thereof, are preferred. A mixture of methacrylic acid methyl ester and methacrylic acid n-butyl ester, in particular in a weight ratio of from 3.5:1 to 16:1, preferably 6:1 to 16:1, is most particularly preferred. Unless specifically indicated otherwise, the alkyl functional groups may generally be straight-chain or branched. Said monomers are used, based on the monomer mixture, in particular in amounts of from 76 to 97.5 wt. %, preferably 85 to 95 wt. %.

The monomer having at least two ethylenically unsaturated groups can generally be any compound that has two ethylenically unsaturated groups, for example two vinyl groups. Examples of suitable compounds include, without being limited hereto, divinyl aromatics, such as in particular divinyl benzenes, or multiesters of a polyol with ethylenically unsaturated carboxylic acids, such as in particular diesters or triesters of a C₂₋₁₀ polyol with ethylenically unsaturated C₃₋₅ carboxylic acids. In various embodiments, said esters are diesters of methacrylic acid or acrylic acid with 1,3-propanediol, 1,4-butanediol or 1,5-pentanediol, in particular a methacrylic acid ester of 1,4-butanediol. Diacrylates and triacrylates or dimethacrylates and trimethacrylates of polyvalent alcohols are preferred.

The above-mentioned compounds having at least two ethylenically unsaturated groups are used as crosslinking agents in the monomer mixtures. Such three-dimensional crosslinking of the resultant polymer is important for ensuring the structural integrity of the nanocapsule even when the polymer swells as the pH rises. The crosslinking agents are used, based on the monomer mixture, in amounts of up to 5 wt. %, preferably up to 4.5 wt. %, more preferably up to 4 wt. %.

In various embodiments of the invention, an ultrahydrophobic compound, in particular a C₁₂₋₂₈ hydrocarbon, more preferably a C₁₄₋₂₆ alkane, such as hexadecane, may also be emulsified in the continuous phase in step (i) together with the monomer mixture, the catalyst/initiator and optionally the release agent. C₁₄₋₂₆ monoalcohols or monocarboxylic acids or also fluorinated derivatives thereof may also be suitable. The catalyst may for example be dissolved therein. In various embodiments, the ultrahydrophobic compound may also be a polymerizable C₁₂₋₂₈ hydrocarbon. Possible compounds are, without being limited hereto, lauryl (meth)acrylate (LA or LMA), tetradecyl (meth)acrylate (TDA or TDMA), hexadecyl (meth)acrylate (HDA or HDMA), octadecyl (meth)acrylate (ODA or ODMA), eicosanyl (meth)acrylate, behenyl (meth)acrylate and mixtures thereof. If ultrahydrophobic polymerizable compounds of this kind are used, these are not included in the calculation of the glass transition temperature that is equivalent to the Fox equation (see above). Said ultrahydrophobic compounds are compounds that are different from the release agent, typically those which, under standard conditions, have a boiling point of >200° C. “Ultrahydrophobic,” as used herein in connection with the above-described compounds, means that the compound in question has a solubility of less than 0.001 wt. % in water at 60° C., as determined by means of the method described by Chai et al. (Ind. Eng. Chem. Res. (2005), 44, 5256-5258).

In various further embodiments of the invention, yet further polymerizable compounds, for example vinylically unsaturated monomers, such as in particular styrene, may also be emulsified in the continuous phase in step (i) together with the monomer mixture. If additional polymerizable compounds of this kind are used, the amount thereof is no more than 50 wt. %, based on the monomer mixture as define above.

In particular preferred embodiments, a mixture of:
(a) 2.5 to 19.0 wt. %, in particular 5.0 to 12.0 wt. %, methacrylic acid (MAA);
(b) 70.0 to 80.0 wt. %, in particular 72.5 to 80.0 wt. %, methyl methacrylate (MMA);
(c) 6.0 to 17.5 wt. %, in particular 5.0 to 12.5 wt. %, n-butyl methacrylate (BMA); and
(d) 0.0 to 5.0 wt. %, in particular 0.5 to 3 wt. %, 1,4-butanediol dimethacrylate (BDDMA) is used.

Mixtures of this kind result in a polymer having the desired glass transition temperature (calculated in a manner equivalent to the Fox equation as described above), for example of >95° C., in particular >100° C. At the same time, these monomer mixtures are sufficiently hydrophobic that stable miniemulsion droplets are produced.

In step (i) of the method, at least one stabilizer is also used. The term “stabilizer,” as used herein, refers to a class of molecules that can stabilize the droplets in an emulsion, i.e., can prevent coagulation and coalescence. To this end, the stabilizer molecules are adsorbed onto the surface of the droplets or interact therewith. (Polymerizable) stabilizers that can covalently react with the monomers used may additionally be used. If polymerizable stabilizers are used, these are not included in the calculation of the glass transition temperature that is equivalent to the Fox equation (see above). Stabilizers generally contain a hydrophilic portion and a hydrophobic portion, the hydrophobic part interacting with the droplet, and the hydrophilic part being directed towards the solvent. The stabilizers may be for example surfactants and may carry an electrical charge. In particular, said surfactants may be anionic surfactants, for example hydrophobically modified polyvinyl alcohol (PVA) or sodium dodecyl sulfate (SDS).

Alternative stabilizers that may be used in the methods described herein are known to a person skilled in the art and include, for example, other known surfactants or hydrophobically modified polar polymers. By means of the stabilizers used, miniemulsion droplets can be produced in the methods according to the invention in the emulsification and optionally homogenization step, which droplets are stabilized and will thus be referred to as “stabilized miniemulsion droplets” in the following.

Accordingly, in some embodiments, the mixtures described herein may also contain further protective colloids, such as polyvinyl alcohols, in particular hydrophobically modified polyvinyl alcohols, cellulose derivatives or vinyl pyrrolidones. A detailed description of compounds of this kind can be found, e.g., in Houben-Weyl, Methoden der Organischen Chemie, vol. 14/1, Makromolekulare Stoffe, Georg-Thieme-Verlag, Stuttgart, 1961, pages 411-420.

The total amount of stabilizer/surfactant is typically up to 30 wt. %, preferably 0.1 to 10 wt. %, more preferably 0.2 to 6 wt. %, based on the total amount of the monomers.

The stabilizer may be used in the form of an aqueous solution. Said solution may, from the composition, correspond to the composition of the continuous phase as defined above.

The emulsion is produced by mixing the various components, for example by means of an Ultra-Turrax, and subsequently optionally homogenized. A miniemulsion is homogenized and thus produced by means of a high-shear process, for example by means of a high-pressure homogenizer, for example at an energy input in the range of from 10³ to 10⁵ J per second per liter of emulsion and/or shear rates of at least 1,000,000/s. A person skilled in the art can easily determine the shear rates by means of known methods.

The high-shear process, as used herein, can take place by means of any known method for dispersing or emulsifying in a high-shear field. Examples of suitable processes can be found, for example, in DE 196 28 142 A1, page 5, lines 1-30, DE 196 28 143 A 1, page 7, lines 30-58, and EP 0 401 565 A 1. Stabilized miniemulsion droplets are obtained by means of the methods described therein.

The monomer mixture is polymerized by means of the corresponding polymerization method, in particular by means of radical polymerization. Polymerization initiators can be used for this purpose. Initiators that can be used include, for example, thermally activatable, radiation-activatable initiators, such as UV initiators, or redox-activatable initiators, and are preferably selected from radical initiators. Suitable radical initiators are known and available, and include organic azo or peroxo compounds. The initiators are preferably water-soluble. If the polymerization is initiated by a water-soluble initiator, free radicals are produced in the aqueous and diffuse to the water/monomer interface in order to initiate the polymerization in the droplets. Examples of suitable initiators include peroxo disulfates, such as potassium peroxodisulfate (KPS), but are not limited thereto.

The polymerization may take place at an increased temperature, for example at a temperature in the range of from 10-90° C., preferably 20-80° C., more preferably 40-75° C., and particularly preferably 60-75° C. The polymerization may take place over a period of time of from 0.1 to 24 hours, preferably 0.5 to 12 hours, more preferably 2 to 6 hours.

The term “approximately,” as used herein in connection with a numerical value, refers to a variance of +20%, preferably ±10%, more preferably ±5% of the value in question. “Approximately 70° C.” therefore means 70±14, preferably 70+7, more preferably 70±3.5° C.

Furthermore, the amount of residual monomers may take place chemically by means of post-polymerization, preferably by using redox initiators, such as those described in DE-A 44 35 423, DE-A 44 19 518 and DE-A 44 35 422. Suitable oxidizing agents for post-polymerization include, without being limited hereto: hydrogen peroxide, t-butyl hydroperoxide, cumene hydroperoxide or alkali peroxosulfates. Suitable reducing agents include, without being limited hereto: sodium disulfite, sodium hydrogen sulfite, sodium dithionite, sodium hydroxymethanesulfite, formamidine sulfinic acid, acetone bisulfate, ascorbic acid and reducing saccharides, and water-soluble mercaptans, such as mercaptoethanol. The post-polymerization by means of a redox initiator may be carried out in a temperature range of from 10 to 100° C., in particular 20 to 90° C. The redox agents may be added, independently of one another, entirely or continuously over a period of time of from 10 minutes to 4 hours.

In order to increase the effectiveness of the redox agents, soluble salts of metals having various valencies, such as iron, copper or vanadium, may be added to the reaction mixture. Complexing agents that keep the metal salts dissolved under the reaction conditions are typically also added.

In order to control the molecular weight of the polymers, a chain-length regulator may be used. Suitable compounds are known in the prior art and include, for example, various thiols, such as 1-dodecanethiol. Chain-length regulators of this kind may be used in the necessary amounts to control the chain length to a desired degree. Typical amounts are in the range of from 0.1 to 5 wt. %, preferably approximately 0.3 to 2.0 wt. %, more preferably approximately 0.5 to 1.0 wt. %, based on the total monomer mass.

In a further aspect, the invention relates to the nanocapsules that can be obtained by means of the method described herein. In various embodiments, said nanocapsules may contain one or more release agents, in particular, propellants, one or more catalysts/initiators and optionally one or more ultrahydrophobic compounds. In particularly preferred embodiments, the propellant is isooctane, the catalyst/initiator is tin neodecanoate, and the ultrahydrophobic compound is hexadecane.

The catalyst can be released from the nanocapsules by increasing the temperature. In the process, in addition to the increasing motion of the polymer chains in the shell above the T_{g}, either the barrier effect of the capsule shell is weakened by said shell swelling up and thus expanding as the compatibility with the encapsulated compounds increases, or, if a propellant is used, the capsule shell is broken open when the temperature is increased above the boiling point of the propellant, and the contents are released. In connection with the nanocapsules and on account of interactions with the polymer, it may also be necessary, in order for the contents to be released, to select a temperature that is up to 50° C. greater than the actual boiling point of the propellant.

The nanocapsules described herein may be used in the catalysis of a plurality of processes, in particular polymerization processes. It is conceivable to use titanium-based catalysts in condensation reactions, for example of silanes or polymers that contain silane groups. Further fields of application are the polymerization of epoxides, benzoxazines and metathesis systems. The use in crosslinking systems, such as elastomers and in particular duromers, is particularly preferred. The fields of application generally include adhesives, sealants, coatings and infusion resins.

Polyurethanes that are intended to be polymerized in a controlled manner when used are a specific field of application. Therefore, nanocapsules of this kind can be used as components of a wide range of compositions containing polyurethanes of this kind. Said compositions may be, for example, adhesives or coating agents based on polyurethanes.

In various embodiments, the compositions containing the nanocapsules described herein therefore further contain at least one polyisocyanate or NCO-functional prepolymer and at least one compound having at least two NCO-reactive groups, in particular at least one polyol. In this case, following the release, the catalyst catalyzes the reaction between the isocyanate (NCO) groups and the NCO-reactive groups, typically hydroxyl groups, which react to form urethane groups in a polyaddition reaction. The polyurethane polymers are thus formed from the monomers or prepolymers. It goes without saying that, in addition to or instead of the described NCO-functional prepolymers, prepolymers having NCO-reactive groups, for example OH-functional prepolymers, may also be used. All compounds typically used in connection with polyurethane synthesis can be used as polyisocyanates and polyols.

In addition to the described nanocapsules, the compositions may, of course, also contain further typical ingredients of such agents.

In principle, all the embodiments disclosed in connection with the nanocapsules and agents of the invention may also be applied to the described methods and uses, and vice versa. It thus goes without saying, for example, that all the specific nanocapsules described herein can be used in the mentioned agents and methods and as described herein.

The following examples are intended to describe the invention, but the invention is not limited thereto.

### EXAMPLES

Materials:

All the monomers, methyl methacrylate (MMA, Merck, ≥99% stab.), butyl methacrylate (BMA, Merck, ≥99% stab.), methacrylic acid (MAA, Acros, 99.5% stab) and 1,4-butanediol dimethacrylate (BDDMA, Sigma Aldrich, 95%), were used as obtained and without further processing. Sodium dodecyl sulfate (SDS, Lancaster, 99%), hexadecane (HD, Merck≥99%) and the initiator potassium peroxodisulfate (KPS, Merck, for analysis) were used as obtained. The matrix-forming monomers, Desmodur Z4470 (trifunctional isocyanate, Bayer, 70% in butyl acetate) and castor oil (hydroxyl number=158 mg KOH/g, VWR International), were used as obtained. Isooctane (IO, ≥99.5%; Carl Roth) and dimethyltin dineodecanoate (Fomrez UL-28, Momentive, 50% in acetone) were used as obtained. Deionized water was used for all experiments.

### Example 1: Catalyst Encapsulation

A mixture of the monomers MMA (3.0 g), BMA (0.4 g), MAA (0.4 g) and BDDMA (0-0.1 g), 0.25 g hexadecane, and 0 g (Ref.), 0.3 g (S1), 0.6 g (S2) or 2.0 g (S3) of dimethyltin dineodecanoate was dissolved in 2 g (Ref.), 1.7 g (S1), 1.4 g (S2) or 0 g (S3) of isooctane. The mixture was then poured slowly into 22 g of water together with 0.023 g of SDS as a stabilizer. For the pre-emulsion, the mixture was homogenized by an Ultra-Turrax at 16,000 rpm for three minutes. The miniemulsion was produced by sonicating the emulsion for 180 seconds (pulsed: ten seconds; five-second pause) at 90% amplitude (Branson sonifier W450 Digital, ½″ tip) whilst being cooled with ice. The miniemulsion was poured into a 100-ml round-bottomed flask, and 0.08 g of KPS dissolved in 2 ml water was added. Polymerization was carried out at 72° C. for five hours with stirring. The solid content was 14%. Unless explicitly indicated otherwise, the final dispersions were dialyzed for 24 hours by means of deionized water in order to remove traces of non-encapsulated material and monomers. The dispersions were subsequently freeze-dried in order to obtain pure nanocapsules.

The dispersions were colloidally stable for several months, and microscope recordings showed a uniform size distribution.

The monomer compositions are listed in Table 1 in wt. %, based on the total amount of monomers. The glass transition temperature T_{g} was calculated by means of the Fox equation.

TABLE 1
Monomer composition (in wt. %), calculated T_{g} of the polymer
shell, capsule sizes (z-average), encapsulation efficiencies

| | Ref. | S1 | S2 | S3 | S4 | S5 |
|---|---|---|---|---|---|---|
| MMA [wt. %] | 76.9 | 76.9 | 76.9 | 76.9 | 79.0 | 78.2 |
| BMA [wt. %] | 10.3 | 10.3 | 10.3 | 10.3 | 10.5 | 10.4 |
| MAA [wt. %] | 10.3 | 10.3 | 10.3 | 10.3 | 10.5 | 10.4 |
| BDDMA [wt. %] | 2.5 | 2.5 | 2.5 | 2.5 | 0 | 1 |
| Catalyst [wt. %] | 0 | 15 | 30 | 100 | 15 | 15 |
| T_{g}¹ [° C.] | 106 | 109 | 103 | 100 | 109 | 116 |
| Capsule diameter² | 193 | 192 | 204 | 197 | 223 | 191 |
| EE_{isooctane} [%] | 85 | 81 | 87 | — | 83 | 92 |
| EE_{catalyst} | — | 81 | 85 | 80 | 106 | 88 |

¹Calculated by means of the Fox equation;
²Z-average (diameter) determined by means of dynamic light scattering (DLS)

The solid content (SC) was determined gravimetrically by freeze-drying the samples. Beforehand, the theoretical solid content was calculated including isooctane as a volatile component. On account of the solid content being determined by freeze drying, the nanocapsules remain intact and the encapsulated ingredients are co-determined when the solid content is measured. On the assumption of complete conversion during polymerization, the amount of encapsulated catalyst and encapsulated isooctane can be calculated by comparing the solid content measured in practice with the above-mentioned theoretical values. The proportion of encapsulated isooctane or catalyst in comparison with the amount used during synthesis is indicated in Table 1 as the encapsulation efficiency EE in percent.

The catalyst amount was determined by means of X-ray fluorescence spectroscopy (XRF) using an Axios Advanced, Panalytical (WD-RFA) X-ray fluorescence spectrometer, provided with an LiF200 crystal, a 300 μm collimator and a scintillation counter as a detector at 60 kV/66 mA. The measurement was carried out at a 2T angle of 14.0318°. The fluorescence was detected using the K_{α} line. The tin extraction took place by means of a low-melting decomposition method for determining volatile element species. For this purpose, approximately 100 mg of the freeze-dried samples was melted at 800° C. together with a mixture of LiNO₃, NaNO₃ and NaB₄O₇. The mixture was subsequently heated to 1,100° C. and tin was quantitatively extracted.

The particle size was measured by means of dynamic light scattering (DLS) using a Malvern Instruments Zetasizer Nano at an angle of 173° (backscattering) and 25° C. For the measurement, the emulsion was diluted with deionized water until a slightly cloudy solution was obtained. The particle size is stated as a z-average [nm].

The results show that the compositions used can efficiently encapsulate the catalyst and the isooctane.

### Example 2: Preparation of the PU Composition

In order to demonstrate the thermolatency of the nanocapsules, a PU system consisting of Desmodur Z4470 and castor oil as a polyol component was used. For this purpose, 1 g of castor oil was mixed with 0.9945 g of Desmodur Z4470 and directly rheologically analyzed. 0.1 wt. % of catalyst was typically added in order to reduce the curing time. The catalyst was added to the castor oil either directly (20.98 mg) or in the form of nanocapsules (1 mg). Capsules that contained no catalyst, only isooctane, were used as a reference.

### Example 3: DSC Measurements

The thermal properties of the freeze-dried samples were measured by means of DSC using a Netzsch 204 F1 Phönix differential scanning calorimeter at heating rates of 10 K/min in a nitrogen atmosphere in a temperature range of from 20-180° C.; 5-10 mg of the capsules were used.

The measurements showed a highly endothermic signal for the isooctane reference sample, which had a starting temperature of 127° C. and a peak temperature of 142° C., which can be attributed to the evaporation of the isooctane. In comparison with the reference, catalyst samples S1, S2, S4 and S5 exhibited a slight downward shift in the starting and peak temperature values (Table 2). As catalyst sample S3 does not contain isooctane, it is not included in the series of experiments. The glass transition temperatures of the copolymer shells were determined in a second heating cycle.

TABLE 2
Temperature behavior

| | Ref. | S1 | S2 | S4 | S5 |
|---|---|---|---|---|---|
| T_{Start} [° C.] | 127 | 119 | 103 | 109 | 116 |
| T_{Peak} [°0] | 142 | 131 | 116 | 119 | 125 |
| T_{g} [° C.] | 147 | 132 | 157 | 139 | 146 |

### Example 4: Determination of Catalyst Effect

Combinations of the nanocapsules or PU systems produced in Examples 1 and 2 were rheologically analyzed. For this purpose, the PU matrix not having a catalyst, the PU matrix having the non-encapsulated catalyst, the PU matrix having the isooctane reference capsules, and the PU matrix having the capsules according to the invention were analyzed with regard to the complex viscosities thereof. The measurements were carried out isothermally at 50° C. as an inactive scenario and 120° C. as an active scenario. The results are shown in FIG. 1a. It is clear that, without a catalyst and in the case of the reference capsules having only isooctane, no change to the viscosity can be observed, i.e., no reaction takes place. In the case of capsules S1 and S2, the viscosity increases linearly at very moderate gradients, the mixture still being workable after several hours. The final viscosity of S2 is approximately twice as a high as that of S1, which demonstrates that a larger amount of catalyst is encapsulated, which can diffuse out of the capsules at higher temperatures. In the case of the non-encapsulated catalyst, the viscosity rises sharply, with the Dahlquist criterion being reached after just five minutes.

At a temperature of 120° C. (FIG. 1b), the pure matrix also exhibits an increase in viscosity, after 35 minutes, as the temperature is sufficient for the crosslinking reaction. The reference capsules exhibit similar behavior. S1 and S2 exhibit a sharp rise in viscosity after a short time.

In a further experiment, the temperature was continuously increased from room temperature to 180° C. (FIG. 1c). S1 does not exhibit an increase in viscosity up to the starting temperature of 115° C., after which polymerization takes places rapidly and is completed within 900 seconds. Nanocapsules S1 therefore exhibit ideal behavior for a thermolatent catalyst. Samples S4 and S5 exhibit shifts to lower starting temperatures, which indicates an influence on the crosslinking density of the capsule shell.

### Example 5: Determination of the Catalyst Effect in Fiber-Reinforced Composites

The PU mixtures produced by means of the S1 capsules were used to produce fiber-reinforced composites. For this purpose, 120 g of the mixture described in Example 4 was poured into a mold filled with glass fibers, by means of a hose pump (Europump PA-ST1 Basic, IKA Labortechnik) (Table 3). The mold was subsequently closed, and curing took place for 2.5 hours at 120° C. in a furnace. Once the mold had cooled, the crosslinked product was removed and the homogeneity of the cured material was determined both visually and by means of FTIR spectroscopy. For this purpose, the isocyanate strips were analyzed at 2,300 cm⁻¹ at each of five measurement points (center and in all four corners). A composite without a catalyst was produced as a comparison.

The catalyzed sample exhibits complete, uniform curing; the non-catalyzed sample cures only in part. This demonstrates that the use of nanocapsules has a positive effect in comparison with microcapsules. The capsules are not filtered out in infusion processes either, which is not possible when microcapsules are used.

TABLE 3
Composition of the fiber-reinforced composites

| | Sample size | Fiber | Weight per | Fiber | Fiber | Thickness | Degree |
|---|---|---|---|---|---|---|---|
| Capsule | [cm × cm] | volume [%] | unit area | directio [symbol] | layers [—] | [mm] | of curing |
| S1 | 13 × 13 | 40 | 1012 | UD* | 3 | 4 | Complet [symbol] |
| S1 | 13 × 13 | 50 | 658 | +/− | 6 | 4 | Complet [symbol] |
| Ref. | 13 × 13 | 40 | 1012 | UD | 3 | 4 | Partial, NCO |
| | | | | | | | peak still |

*Unidirectional glass fibers
** Biaxially oriented glass fibers +/−45°, Saertex (item no. V1032882) [symbol]
indicates data missing or illegible when filed

### Example 6: Catalyst Encapsulation Using Castor Oil Instead of Isooctane

A mixture of the monomers MMA (3.0 g), BMA (0.4 g), MAA (0.4 g) and 0.25 g hexadecane, and 0 g (Ref. 2) or 0.2 g (S6) of dimethyltin dineodecanoate was dissolved in 2.0 g (Ref. 2) or 1.82 g (S6) of castor oil. The mixture was then poured slowly into 22 g of water together with 0.023 g of SDS as a stabilizer. For the pre-emulsion, the mixture was homogenized by an Ultra-Turrax at 16,000 rpm for three minutes. The miniemulsion was produced by sonicating the emulsion for 180 seconds (pulsed: ten seconds; five-second pause) at 90% amplitude (Branson sonifier W450 Digital, ½″ tip) whilst being cooled with ice. The miniemulsion was poured into a 100-ml round-bottomed flask, and 0.08 g of KPS dissolved in 2 ml water was added. Polymerization was carried out at 72° C. for five hours with stirring. The solid content was 14%. Unless explicitly indicated otherwise, the final dispersions were dialyzed for 24 hours by means of deionized water in order to remove traces of non-encapsulated material and monomers. The dispersions were subsequently freeze-dried in order to obtain pure nanocapsules.

The monomer compositions are listed in Table 4 in wt. %, based on the total amount of monomers. The glass transition temperature T_{g} was calculated by means of the Fox equation.

TABLE 4
Monomer composition (in wt. %), calculated T_{g} of the polymer
shell, capsule sizes (z-average), encapsulation efficiencies

| | Ref. 2 | S6 |
|---|---|---|
| MMA [wt. %] | 76.9 | 76.9 |
| BMA [wt. %] | 10.3 | 10.3 |
| MAA [wt. %] | 10.3 | 10.3 |
| Catalyst [wt. %] | 0 | 10 |
| Tg¹ [° C.] | 109 | 109 |
| Capsule diameter² | 205 | 160 |
| EE_{castoroil} [%] | 74 | 72 |

The dispersions were colloidally stable for several months, and microscope recordings showed a uniform size distribution.

### Example 7: Determination of the Catalyst Effect for the Castor Oil Capsules

The nanocapsules or PU systems produced in Example 5 were rheologically analyzed. For this purpose, the PU matrix not having a catalyst, the PU matrix having the non-encapsulated catalyst, the PU matrix having the castor oil reference capsules, and the PU matrix having the capsules according to the invention were analyzed with regard to the complex viscosities thereof. The measurements were carried out isothermally at 50° C. as an inactive scenario and 120° C. as an active scenario. The results are shown in FIG. 1d). It is clear that, without a catalyst and in the case of the reference capsules having only castor oil, no change to the viscosity can be observed, i.e., no reaction takes place. In the case of capsules S6, the viscosity increases linearly at very moderate gradients, the mixture still being workable after several hours. In the case of the non-encapsulated catalyst, the viscosity rises sharply, with the Dahlquist criterion being reached after just five minutes.

At a temperature of 120° C. (FIG. 1e), the matrix containing the Ref. 2 capsules also exhibits an increase in viscosity, after 35 minutes, as the temperature is sufficient for the crosslinking reaction. Similarly, to S1, S6 exhibits a sharp rise in viscosity after a short time.

### BRIEF DESCRIPTION OF THE DRAWINGS

FIG. 1a is a rheological analysis at 50° C. of combinations of the nanocapsules or PU systems produced in Examples 1 and 2. For this purpose, the PU matrix not having a catalyst, the PU matrix having the non-encapsulated catalyst, the PU matrix having the isooctane reference capsules, and the PU matrix having the capsules according to the invention were analyzed with regard to the complex viscosities thereof.

FIG. 1b is a rheological analysis at 120° C. of combinations of the nanocapsules or PU systems produced in Examples 1 and 2.

FIG. 1c) is a rheological analysis of combinations of the nanocapsules or PU systems produced in Examples 1 and 2 where the temperature was continuously increased from room temperature to 180° C.

FIG. 1d) is a rheological analysis at 50° C. of the nanocapsules or PU systems produced in Example 5. For this purpose, the PU matrix not having a catalyst, the PU matrix having the non-encapsulated catalyst, the PU matrix having the castor oil reference capsules, and the PU matrix having the capsules according to the invention were analyzed with regard to the complex viscosities thereof.

FIG. 1e) is a rheological analysis at 120° C. of the nanocapsules or PU systems produced in Example 5.

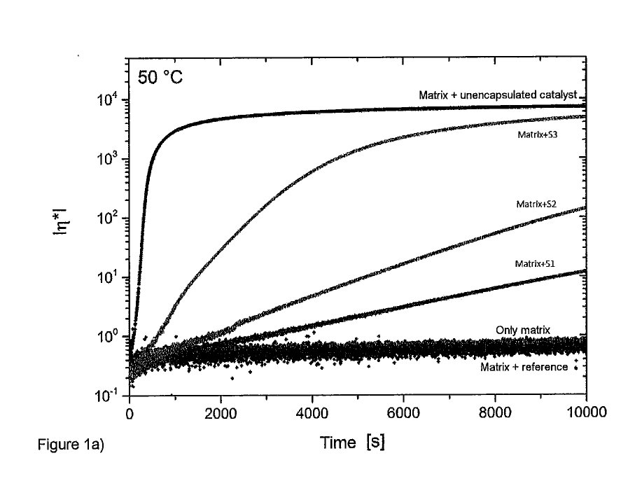

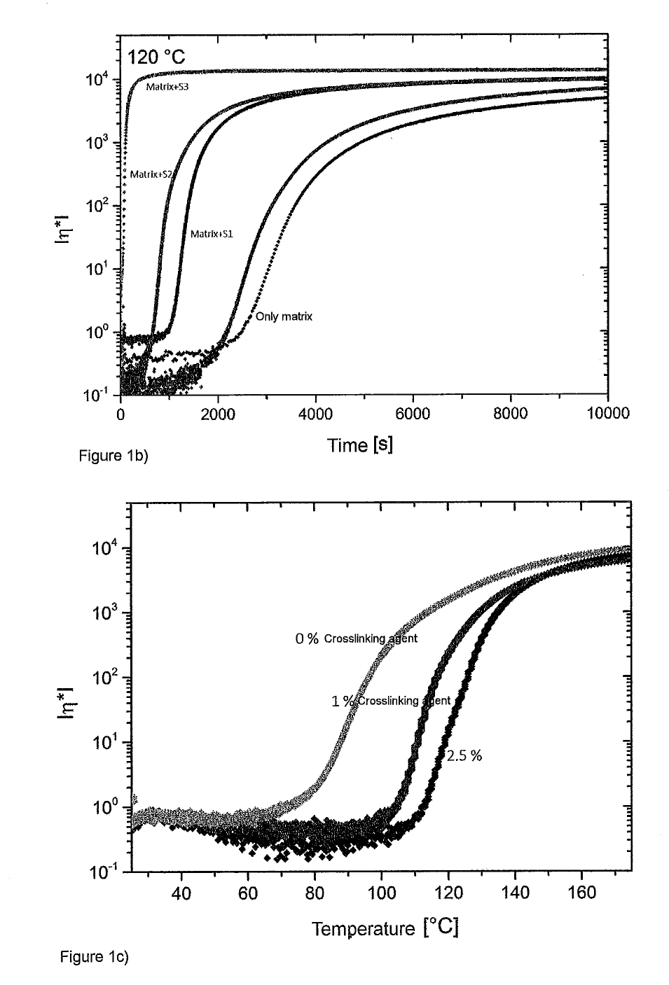

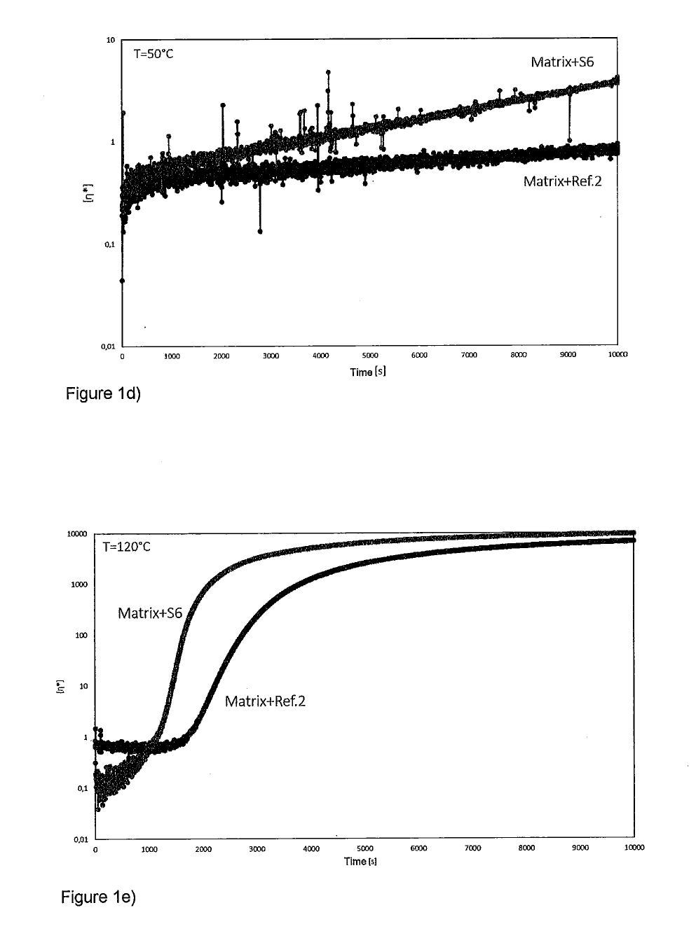

1. A method for producing nanocapsules having at least a partial shell containing at least one polymerization catalyst/initiator, comprising:
(i) emulsifying a reaction mixture in a continuous aqueous phase that comprises at least one stabilizer, the reaction mixture comprising, based on the total weight of the reaction mixture:
(a) 10.0 to 99.0 wt. % of a monomer mixture which, based on the total weight of the monomer mixture, comprises:
(a1) 2.5 to 19.0 wt. % of at least one ethylenically monounsaturated C₃₋₅ carboxylic acid monomer,
(a2) 76.0 to 97.5 wt. % of at least one ethylenically monounsaturated C₃₋₅ carboxylic acid C₁₋₁₀ alkyl ester monomer,
(a3) 0.0 to 5.0 wt. % of at least one monomer having at least two ethylenically unsaturated groups;
(b) 1.0 to 70.0 wt. % of at least one polymerization catalyst or initiator;
(c) 0.0 to 89.0 wt. % of at least one hydrophobic release agent; and
(d) 0.0 to 10.0 wt. % of at least one ultrahydrophobic compound that is different from the release agent;
(ii) optionally homogenizing the emulsion from step (i); and
(iii) polymerizing the monomers.

2. The method according to claim 1, wherein the monomers in the monomer mixture are selected such that the copolymer obtained from the monomer mixture has a theoretical glass transition temperature T_{g}, calculated in a manner equivalent to the Fox equation, of 95° C. or more.

3. The method according to claim 1, wherein the average size of the nanocapsules is in the size range of from 50 to 500 nm.

4. The method according to claim 1, wherein the at least one polymerization catalyst/initiator:
(a) has a Hansen parameter δₜ of less than 20 MPa^{1/2}; and/or
(b) has a Hansen parameter δₕ of less than 12 MPa^{1/2}.

5. The method according to claim 1, wherein the at least one hydrophobic release agent is present in the reaction mixture and:
(a) has a Hansen parameter δₜ of less than 19 MPa^{1/2}; and/or
(b) has a Hansen parameter δₕ of less than 12 MPa^{1/2}.

6. The method according to claim 1, wherein the Hansen parameter δ_{d} of the polymerized monomers is 15-19 MPa^{1/2}; the Hansen parameter δₚ is 10-14 MPa^{1/2}; the Hansen parameter δh is 13-17 MPa^{1/2}; and the Hansen parameter δₜ is preferably 23-28 MPa^{1/2}.

7. The method according to claim 6, wherein the at least one polymerization catalyst or initiator and optional at least one hydrophobic release agent and optional at least one ultrahydrophobic compound define a mixture to be encapsulated; the polymerized monomers define a polymer of the nanocapsule shell and the mixture to be encapsulated and the polymer of the nanocapsule shell satisfy the following relationship:
Rₐ/R₀>1, where
(Rₐ)²=(δ_{dS}−δ_{dP})²+(δ_{pS}−δ_{pP})²+(δ_{hS}−δ_{hP})²
where S represents the mixture to be encapsulated and P represents the polymer of the nanocapsule shell, where R₀ is 8-15 MPa^{1/2}.

8. The method according to claim 1, wherein the at least one ethylenically monounsaturated C₃-C₅ carboxylic acid monomer is selected from methacrylic acid (MAA), acrylic acid (AA), fumaric acid, methyl maleic acid, maleic acid, itaconic acid or mixtures of two or more thereof.

9. The method according to claim 1, wherein the at least one ethylenically monounsaturated C₃₋₅ carboxylic acid C₁₋₁₀ alkyl ester monomer is an acrylic acid or methacrylic acid alkyl ester or mixture thereof.

10. The method according to claim 1, wherein the at least one ethylenically unsaturated C₃₋₅ carboxylic acid C₁₋₁₀ alkyl ester monomer is a mixture of methacrylic acid methyl ester and methacrylic acid n-butyl ester in a weight ratio of from 3.5:1 to 16:1.

11. The method according to claim 1, wherein the at least one monomer having at least two ethylenically unsaturated groups comprises a diester of methacrylic acid or acrylic acid with 1,3-propanediol, 1,4-butanediol or 1,5-pentanediol.

12. The method according to claim 1, wherein the at least one stabilizer is an anionic surfactant.

13. The method according to claim 1, wherein the at least one release agent is present in the reaction mixture and is liquid at room temperature (20° C.) and normal pressure (1,013 mbar).

14. The method according to claim 1, wherein the release agent is present in the reaction mixture and is a reactive release agent which, during polymerization, is at least in part copolymerized with the capsule shell and is selected from castor oil, cardanol and derivatives thereof.

15. The method according to claim 1, wherein the release agent is present in the reaction mixture and is a hydrocarbon, having a boiling point of from 50 to 200° C.

16. The method according to claim 1, wherein the at least one polymerization catalyst is selected from organotin compounds for the polymerization of polyurethanes.

17. Nanocapsules prepared from the method of claim 1.

18. A composition comprising the nanocapsules according to claim 17, and a polymerizable resin.

19. The composition according to claim 18, wherein the composition is an adhesive, a sealant, an infusion resin or a coating agent.

20. A composition comprising the nanocapsules according to claim 17, a polyisocyanate or NCO-functional prepolymer and at least one compound having at least two NCO-reactive groups.
